(19) United States
(12) Patent Application Publication
(10) Pub. No.: US 2026/0070087 A1
(43) Pub. Date: Mar. 12, 2026

(54) Ultrawide Beam Transducer

(71) Applicant: Airmar Technology Corporation, Milford, NH (US)

(72) Inventors: Stephen G. Boucher, Amherst, NH (US); Dylan Fyler, Hudson, NH (US)

(21) Appl. No.: 18/882,669

(22) Filed: Sep. 11, 2024

(51) Int. Cl. B06B 1/06

(52) U.S. Cl. CPC B06B 1/0637; B06B 2201/74

(57) ABSTRACT

A transducer device that can generate a wide, ultra-wide, or wide-angle acoustic beam within or through water. The transducer device can include a transducer element configuration having an acoustic emission portion that has a concave shape for generating a series of acoustic beams that cross each other to collectively form a wide-angle acoustic beam.

### BACKGROUND

Fishing boats often use fish finders that generate acoustic beams into the water below the boat for detecting fish. A fish finder with a wide acoustic beam is desirable in order to cover a large area of water to find fish.

### SUMMARY

The present disclosure provides a transducer device that can generate a wide, ultra-wide, or wide-angle acoustic beam within or through water. The transducer device can include a transducer element configuration or assembly having an acoustic emission portion that has a concave shape for generating a series of acoustic beams that cross each other to collectively form a wide-angle acoustic beam.

In particular embodiments, the transducer element configuration can include a series of individual transducer elements, each having an acoustic emission surface, that are positioned in a concave arrangement. The individual transducer elements can be arranged around a radius of curvature of ¾λ to 10λ, where λ is the wavelength water at 80 kHz. In some embodiments, the transducer elements can be arranged around a radius curvature of 1λ. In some embodiments, the transducer element configuration can include seven individual transducer elements, each having a length and width that extend along or in respective longitudinal and lateral directions. The radius of curvature can extend around a longitudinal axis in the longitudinal direction. The wide-angle acoustic beam at −3 dB can be about 55° to 106° in the lateral direction and about 13° to 40° in the longitudinal direction. In some embodiments, the wide-angle acoustic beam can be about 57° to 73° in the lateral direction and about 16° in the longitudinal direction. A generally circular housing can surround the transducer element configuration. The housing can have a window through which the wide-angle acoustic beam passes. The individual transducer elements can be secured within a mounting fixture that positions the transducer elements in the concave arrangement. In some embodiments, the transducer element configuration can include 3to 7 transducer elements. The individual transducer elements can be elongate, and each can have a length. The transducer elements can be positioned laterally relative to each other, and the lengths of the transducer elements at opposite lateral sides of the transducer element configuration can be shorter in length than any transducer elements therebetween, in order to fit within the generally circular housing.

The present disclosure can also provide a transducer device including a transducer element configuration or assembly having an acoustic emission portion that has a concave shape. The transducer element configuration can include seven individual transducer elements, each having a length and width that extend along or in respective longitudinal and lateral directions.

The transducer elements can each have an acoustic emission surface, and can be positioned in a concave arrangement around a radius of curvature of 1λ. The radius of curvature can extend around the longitudinal direction. The acoustic emission portion can generate a series of acoustic beams that cross each other to collectively form a combined wide-angle acoustic beam.

The present disclosure can also provide a method of generating a wide-angle acoustic beam with a transducer device, including generating a series of acoustic beams that cross each other to collectively form the wide-angle acoustic beam with a transducer element configuration having an acoustic emission portion that has a concave shape.

In particular embodiments of the method, the transducer element configuration can include a series of individual transducer elements, each having an acoustic emission surface, that are positioned in a concave arrangement. The individual transducer elements can be arranged around a radius of curvature of ¾λ to 10λ, where λ is the wavelength of water at 80 kHz. In some embodiments, the transducer elements can be arranged around a radius of curvature of 1λ. In some embodiments, the transducer element configuration can include seven individual transducer elements, each having a length and width that extend along or in respective longitudinal and lateral directions. The radius of curvature can extend around a longitudinal axis in the longitudinal direction. The wide-angle acoustic beam at −3 dB can be about 55° to 106° in the lateral direction and about 13° to 40° in the longitudinal direction. In some embodiments, the wide-angle acoustic beam can be about 57° to 73° in the lateral direction and about 16° in the longitudinal direction. The transducer device can further include a generally circular housing surrounding the transducer element configuration. The housing can have a window, and the wide-angle acoustic beam can be emitted through the window of the housing. The individual transducer elements can be secured within a mounting fixture that positions the transducer elements in the concave arrangement. In some embodiments, the transducer element configuration can include 3 to 7 transducer elements. The individual transducer elements can be elongate, and each can have a length. The transducer elements can be positioned laterally relative to each other, and the lengths of the transducer elements at opposite lateral sides of the transducer element configuration can be shorter in length than any transducer elements therebetween, in order to fit within the generally circular housing.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a side schematic view of a boat with an embodiment of a transducer device in the present disclosure generating an acoustic beam within water.

FIG. 2 is a front schematic view of the boat and the transducer device generating the acoustic beam within the water.

FIG. 3 is a top schematic view of the boat and the transducer device generating the acoustic beam.

FIG. 4 is a side sectional view of an embodiment of the transducer device.

FIG. 5 is a perspective view of an embodiment of a transducer element configuration for the transducer device.

FIG. 5A is a bottom schematic view of the transducer device.

FIG. 6 is an end view of an embodiment of an individual transducer element.

FIG. 7 is a schematic drawing of the transducer device generating a wide-angle acoustic beam.

FIGS. 8A-8C are graphs depicting acoustic beam widths in fore-aft and port-starboard axes for 60 kHz, 80 kHz and 100 kHz.

FIG. 9 is a schematic comparison drawing of transducer element configurations having a radius of curvature of 10λ, 2λ, 1λ and 3/4λ.

FIG. 10 is a comparison graph of beam angle for the transducer element configurations of FIG. 9.

FIG. 11 is a side sectional view of another embodiment of the transducer device.

FIG. 12 is a schematic drawing of an embodiment of another transducer element configuration.

### DETAILED DESCRIPTION

A description of example embodiments follows.

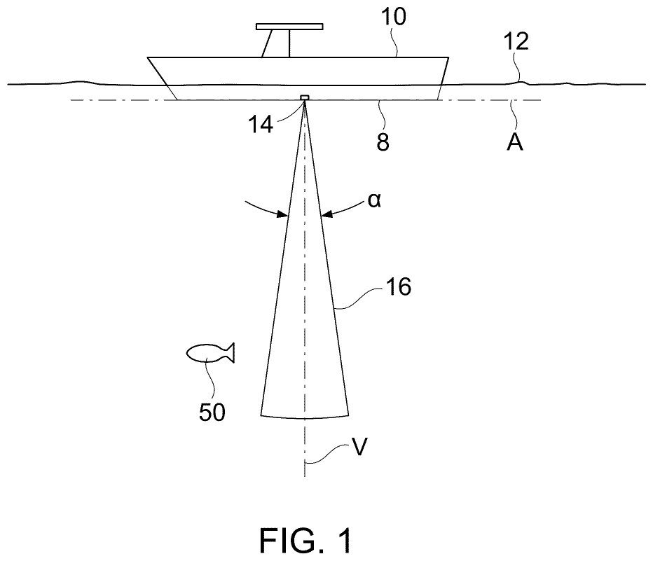

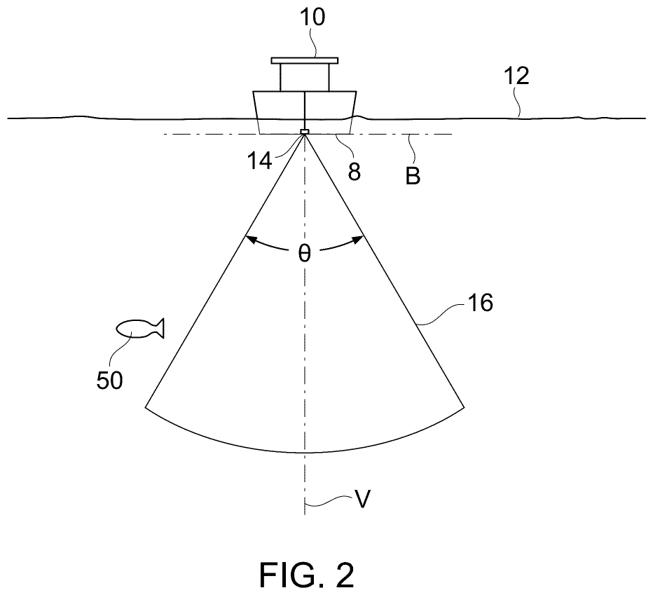

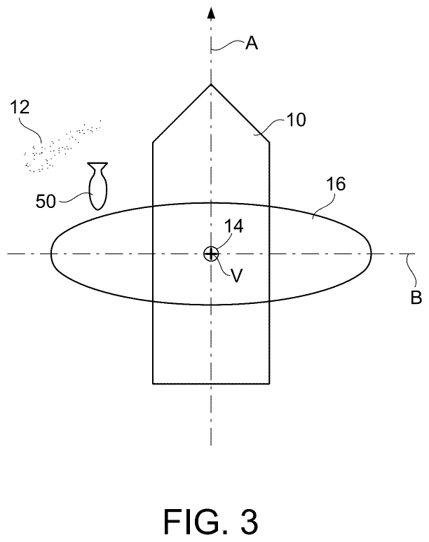

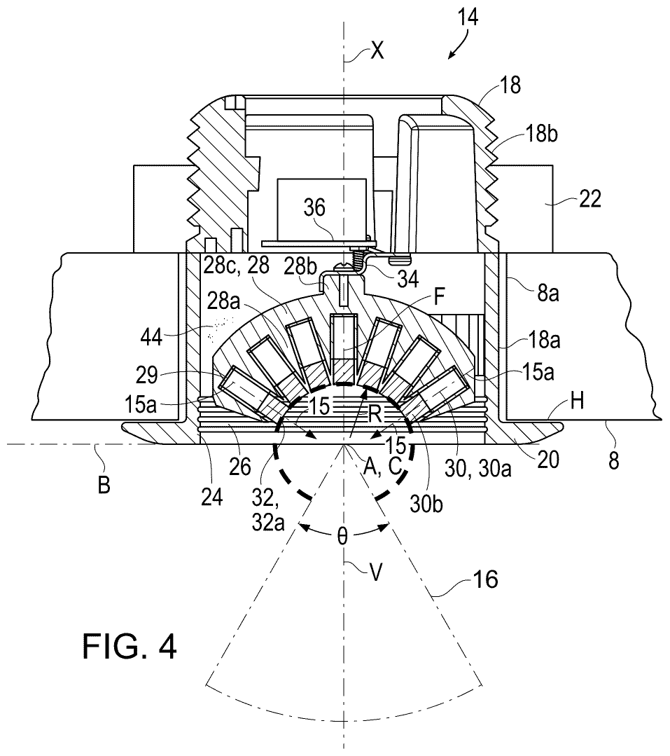

Referring to FIGS. 1-3, an acoustic fish finder, marine transducer or transducer device 14 in the present disclosure can be mounted to a watercraft, ship or boat 10, such as through an opening or hole 8a (FIG. 4) in the bottom of the hull 8 of the boat 10, for generating a wide-angle acoustic, sound or sonic beam 16 downwardly into or within the water 12. The transducer 14 can be oriented or positioned to provide an acoustic beam 16 having a smaller angle α in the longitudinal fore—aft direction along a longitudinal axis A, such as about 13°-40°, typically about 16°, while having a larger angle θ in the lateral port—starboard direction along a lateral axis B, such as 55°-106°, typically 57°-73°, often about 60°. The acoustic beam 16 can be directed downwardly into the water 12 along the axis V, that can be a vertical axis or near vertical axis. The wide-angle acoustic beam 16 in the lateral direction along axis B provides coverage of a wide area of water 12 for better detecting fish 50 directly under the boat 10 and along the sides under the boat 10. The transducer 14 can be a Compressed High Intensity Radar Pulse (CHIRP) sonar device that can operate at a medium frequency band from 60- 100 kHz, which can allow detection of fish 50 at depths of 1300 feet. The sonar images of the fish 50 can have the appearance of an arch shape.

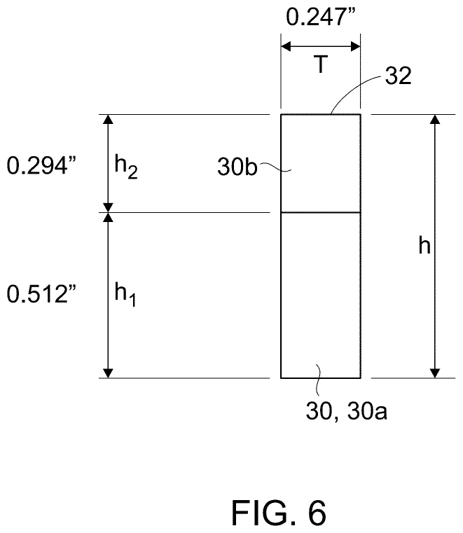

Referring to FIGS. 4-7, transducer 14 can include a housing 18 which can be generally cylindrical in shape, and can be mounted within a round hole or opening 8a in the bottom of the hull 8 of boat 10. The housing 18 can have a generally cylindrical sidewall 18a with a bottom hole, opening, exit or acoustic window 24, a bottom flange 20 extending from the sidewall 18a radially outwardly from the bottom opening or exit window 24, and an upper threaded region 18b for engaging a mating threaded member or nut 22. The housing 18 can be secured and sealed to the hull 8 by inserting the housing 18 through the bottom of the hole 8a so that the bottom flange 20 engages the bottom surface of the hull 8, and the nut 22 is tightened on the upper threaded region 18b to sandwich the hull 8 between the flange 20 and the nut 22 for sealing the housing 18 to the hull 8.

The transducer 14 can have a transducer element arrangement, configuration or assembly 28 positioned within the interior 26 of the housing 18 for generating the acoustic beam 16 downwardly out through the exit window 24 along axis V. The center axis F of the transducer assembly 28 can be aligned with the longitudinal axis X of the housing 18 and axis V. The transducer assembly 28 can include a mounting bracket, body, or fixture 28c that can have a bottom portion 28a with a generally concave arch shape, having a series of evenly spaced retention or receiving recesses or slots 29 formed therein, that hold, position and space a respective series of acoustic transducer elements, bars or members 30 therein in side by side arrangement, for generating acoustic, sound or sonic beams. The mounting fixture 28c can have a stem 28b that is secured to a bracket 34 that mechanically and electrically connects the transducer assembly 28 to electronics 36. The transducer elements 30 can include elongate piezoelectric bars 30a which can be porous for improved bandwidth along with an acoustic impedance that has a closer match to water 12. A matching layer of polymeric material 30b can be formed on the bottom or distal surface of each bar 30a for further matching with water 12, and each transducer element 30 can have a flat acoustic radiating, emission or transmission surface 32 on the matching layer 30b for emitting multiple individual or separate initial acoustic beams 15. The transducer elements 30 and the acoustic emission surfaces 32 of the transducer elements 30 can be arranged or positioned in a concave arrangement around a radius of curvature R, to collectively form an acoustic emission or transmission portion 32a of the transducer element assembly 28 that has a concave arch shape. The acoustic emission surfaces 32 of the transducer elements 30 can be positioned in an arc around the radius R, which has a center C along longitudinal axis A, where the initial individual acoustic beams 15 generated by the transducer elements 30 cross, superimpose, and/or combine, to collectively form a wide-angle acoustic beam 16 extending or widening in the lateral direction or axis B. The acoustic emission surfaces 32 can be coincident with the radius of curvature R. The transducer assembly 28 can be inset or positioned slightly above exit window 24 with the concave shape of the acoustic emission portion 32a downwardly facing the exit window 24 and centrally aligned along the central longitudinal axis X of the housing 18. The transducer assembly 28 and the transducer elements 30 can be encapsulated within the interior 26 of the housing 18 with polyurethane 44, which provides sealing from the water 12 and can provide further acoustic matching with the water 12.

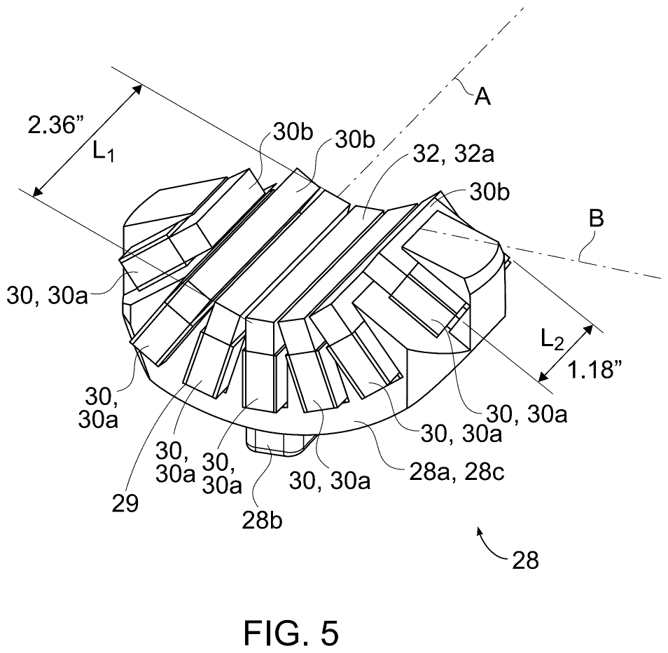

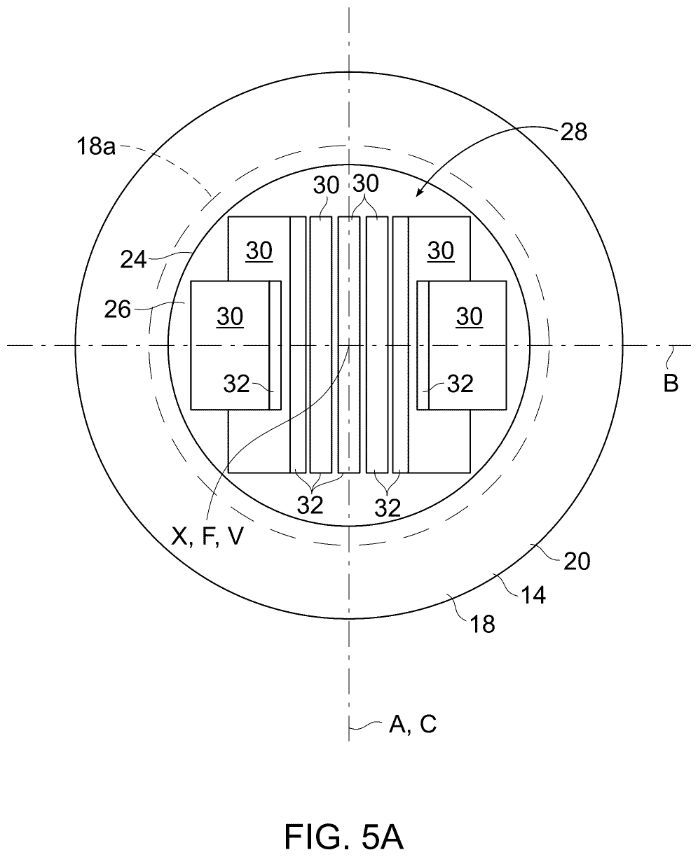

In some embodiments, the transducer assembly 28 can include seven spaced apart individual or separated rectangular elongate bar shaped transducer elements 30 with the elongate sides laterally positioned close to each other and parallel to longitudinal axis A, such that the acoustic emission surfaces 32 are positioned adjacent to each other in an arc about center C and axis A with a radius R of 1λ, where λ is the wavelength of water at 80 kHz. In some embodiments, this radius R can be about 1 inch (for example about 0.9 inches). Embodiments of each transducer element 30 can have a height h of about ¾ to 13/16 inches (can be about 0.806 inches), with the piezoelectric bar 30a having a height h₁ of about ½ to 9/16 inches (can be about 0.512 inches), and the polymeric matching layer 30b can have a height h₂ of about ¼ to 5/16 inches (can be about 0.294 inches). The thickness T of each transducer element 30 can be 3/16 to ¼ inches (can be 0.247 inches). The length L₁ of the five inner transducer elements 30 can be about 2 5/16 to 2⅜ inches (can be about 2.36 inches), and the length L₂ of the two outer or end transducer elements 30 can be about 1⅛ to 1¼ inches (can be about 1 3/16 or 1.18 inches). This can allow the transducer assembly 28 to be positioned within a cylindrical housing 18 that has a body with an outer diameter of about 3.75 inches, an inner diameter of about 3.4 inches, and height of about 3⅞ inches (can be 3.86 inches). As can be seen in FIGS. 4, 5 and 5A, the two outermost transducer elements 30 at each end or side, can be angled such that the proximal faces or portions opposite to emission surfaces 32 are positioned close to the inner surfaces of the sidewalls 18a of housing 18. The flange 20 can have an outer diameter of about 5⅜ inches and a thickness of about ¼ inches. The shorter lengths L₂ of the two outer, end or side transducer elements 30, allows the acoustic emission portion 32a to be greater in width along the lateral axis B or port—starboard direction, while fitting into the circular interior 26 of the housing 18, than if all the transducer elements 30 had the same length L₁. This can also make the transducer assembly 28 have a ratio between the lateral width in the direction of lateral axis B relative to the length in the direction of longitudinal axis A, of about 1.25 to 1.

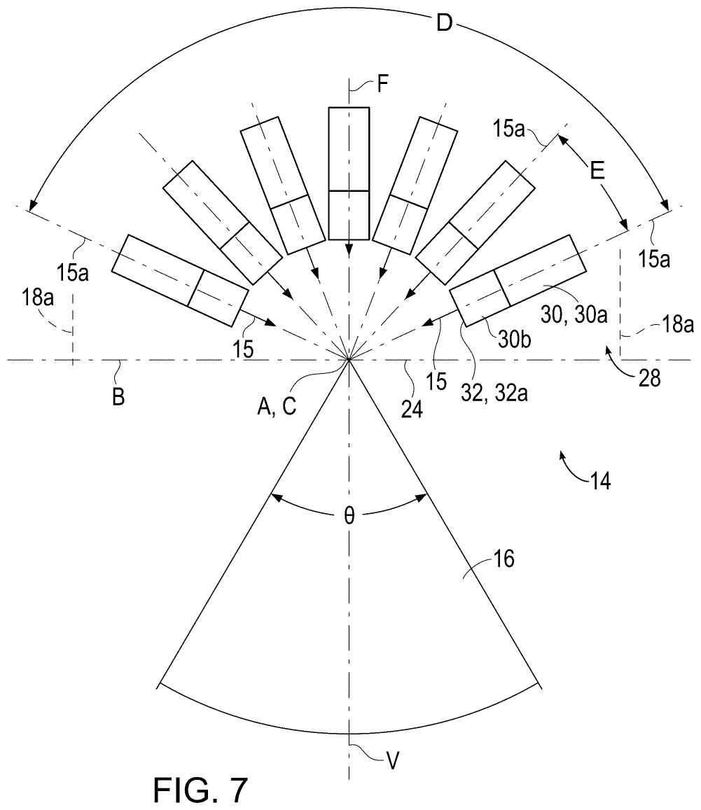

Each transducer element 30 can have an emission or transmission centerline or axis 15a along which each transducer element 30 produces, generates, emits or transmits an individual or separate initial or first acoustic beam 15 from the acoustic emission surface 32 towards center C. The transducer elements 30 can be evenly positioned apart from each other an equal angle E which can be about 21°- 22°(such as 21.6°) between the emission axes 15a of the transducer elements 30. The transducer element or assembly arc angle D between the axes 15a of the two transducer elements 30 at the ends can be about 130°. By having seven narrow transducer elements 30 positioned with such angular spacing, the acoustic emission surfaces 32 of the transducer elements 30 can collectively form an acoustic emission portion 32a with a profile that approximates an arc in a relatively smooth manner. In addition, the narrow transducer elements 30 can have reduced lateral acoustic resonances occurring in the operating frequency band, and multiple transducer elements 30 can allow power to be increased for deep water use. The concave shape of the acoustic emission portion 32a allows the bottom of the transducer assemblies 28 to be positioned within the interior 26 of the housing 18 inset near the exit window opening 24. If the transducer assembly 28 had a convex acoustic emission portion for producing a wide-angle acoustic beam, such a convex acoustic emission portion would have to extend below the housing 18 so that the sidewalls of the housing 18 would not block or shadow the edges of the acoustic beam. As can be seen in FIGS. 4 and 7, the initial acoustic beams 15 in the D=130° arc from the transducer elements 30 can all be directed out the exit window 24 without the side walls 18a of the housing 18 blocking any of the initial acoustic beams 15. The positioning and angle of the initial acoustic beams 15 from the transducer elements 30 at the ends of the transducer assembly 28 can allow the initial acoustic beams 15 to have a clear path out the exit window 24.

The initial acoustic beams 15 generated along the arc angle D from the transducer elements 30 can angle downwardly towards each other in a converging manner, and cross, superimpose and/or combine with each other at or near the center C along the longitudinal axis A. The initial acoustic beams 15 converge at angles relative to each other, and the resulting angle of the combined or collective secondary or second wide-angle acoustic beam 16 that emerges from the center C in a downwardly diverging or outwardly spreading manner, typically has a smaller angle θ in the direction of axis B than the arc angle D of the transducer assembly 28. The collective acoustic beam 16 can have an angle α in the direction of axis A that is about 22% to 40% of the beam width of angle θ in the direction of axis B, depending upon the frequency, since the transducer elements 30 are flat or planar in the direction parallel to axis A, and do not have a concave shape.

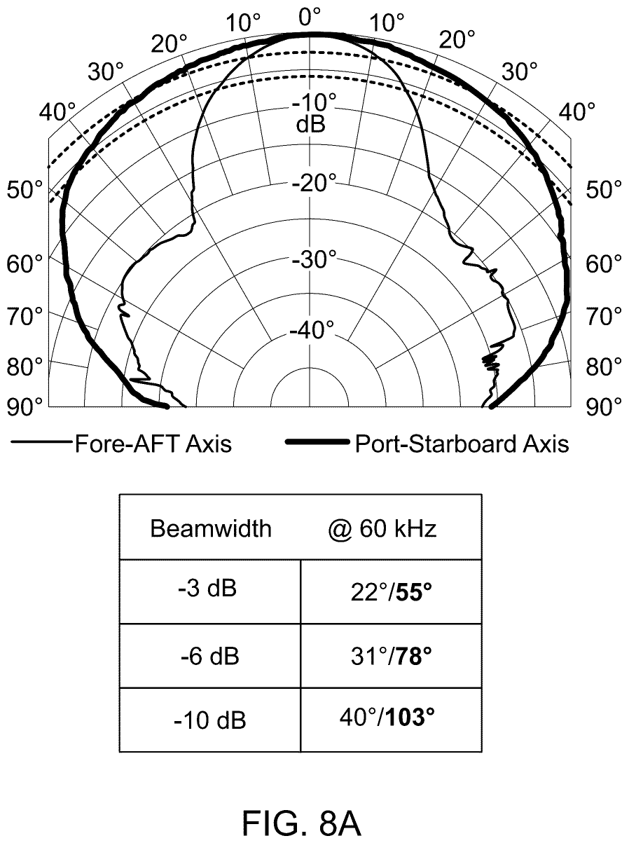

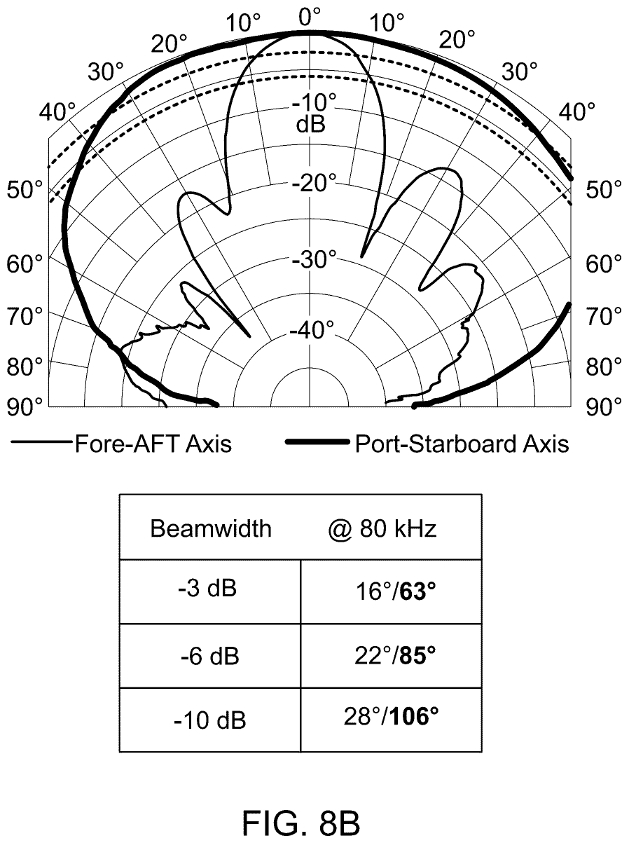

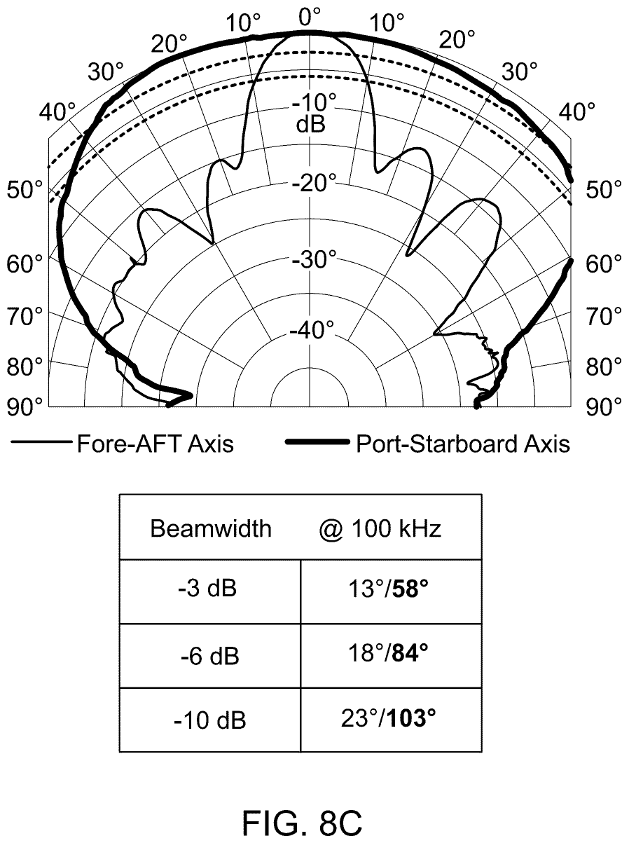

Embodiments of the transducer assembly 28 of transducer 14 can be a 1 kW transducer and can be operated with a CHIRP transceiver to operate at medium frequencies, between 60 kHz and 100 kHz. In particular embodiments, referring to FIG. 8A, when operating at 60 kHz, at −3 dB the acoustic beam 16 can have an angle α=22° in the fore-aft axis A direction, and an angle θ=55° in the port-starboard axis B direction; at −6 dB the acoustic beam 16 can have an angle α=31° in the axis A direction, and an angle θ=78° in the axis B direction; and at −10 dB the acoustic beam 16 can have an angle α=40° in the axis A direction, and an angle θ=103° in axis B direction. Referring to FIG. 8B, when operating 80 kHz, at −3 dB the acoustic beam 16 can have an angle α=16° in the axis A direction, and an angle θ=63° in the axis B direction; at −6 dB the acoustic beam 16 can have an angle α=22° in the axis A direction, and an angle θ=85° in the axis B direction; and at −10 dB the acoustic beam 16 can have an angle α=28° in the axis A direction, and an angle θ=106° in the axis B direction. Referring to FIG. 8C, when operating at 100 kHz, at −3 dB the acoustic beam 16 can have an angle α=13° in the axis A direction, and an angle θ=58° in the axis B direction; at −6 dB the acoustic beam 16 can have an angle α=18° in the axis A direction, and an angle θ=84° in the axis B direction; and at −10 dB the acoustic beam 16 can have an angle α=23° in the axis A direction, and an angle θ=103° the axis B direction.

The use of multiple transducer elements 30 in the transducer assembly 28 can allow higher power to be used. Although seven transducer elements 30 are shown, the concave arrangement or positioning of the transducer elements 30 still can generate a wide acoustic beam 16 in the axis B direction despite the individual initial acoustic beams 15 crossing, superimposing and/or combining with each other. Using shorter transducer elements 30 at the ends of the transducer assembly 28 can maximize the active transducer area and power within a circular housing 18, while providing reduced side lobes. In some embodiments, the transducer assembly 28 can have a ratio between the lateral width in the axis B direction to the longitudinal length in the axis A direction of about 1.25 to 1. In some embodiments the gaps or spaces between the sides or edges of the separate or individual acoustic emission surfaces 32 of the transducer elements 30 can be about 0.02 to 0.03 inches, and can form sonic separation or insulation gaps. In some embodiments, housing 18 can extend only 8 mm below the hull 8, and the concave shape of the transducer assembly 28 can minimize shadowing or blocking effects from the inner surfaces of the sidewalls 18a of the housing 18, since the transducer elements 30 at the ends of the transducer assembly 28 can direct their initial acoustic beams 15 downwardly at an angle out of the exit window 24 at the center of the exit window 24 and away from the sidewalls 18a of the housing 18. The use of seven transducer elements 30 with the dimensions mentioned above and arranged around a radius of 1λ, can provide a relatively smooth concave shape with a small number of transducer elements 30, minimal parasitic lateral resonances and disruptions to the −3 dB bandwidth.

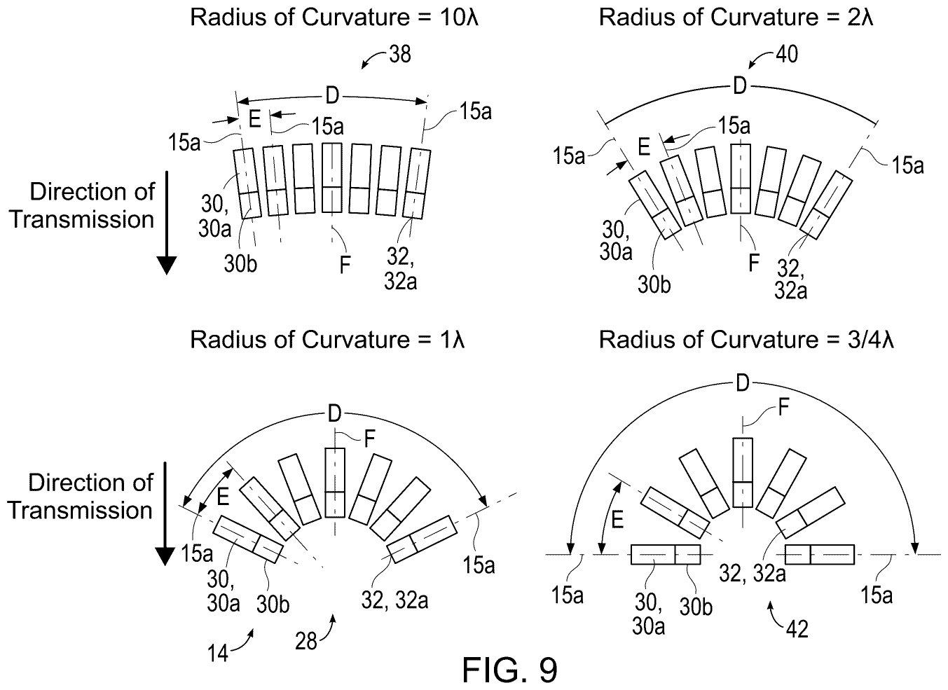

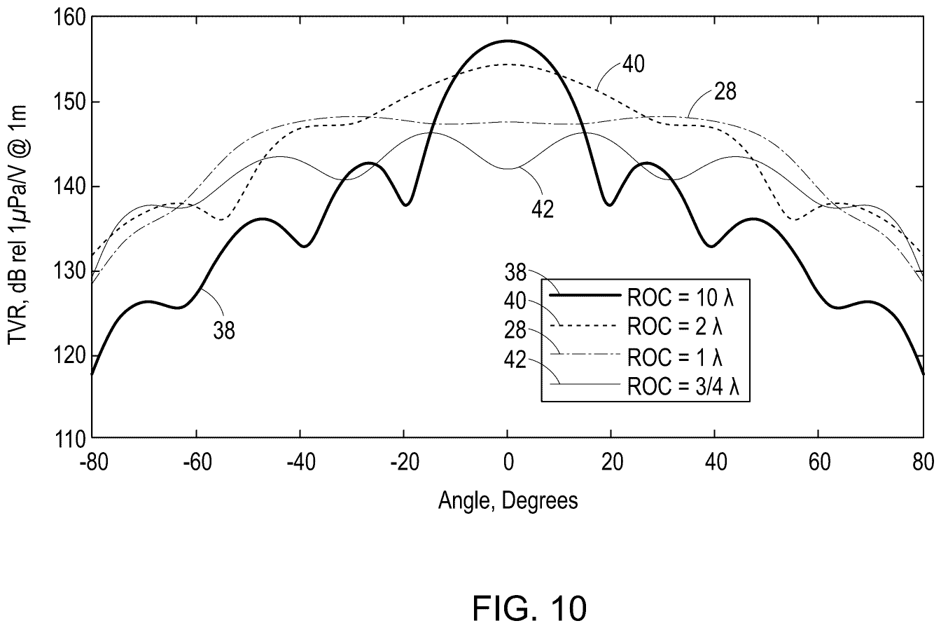

FIGS. 9 and 10 show a comparison of an embodiment of transducer assembly 28 of transducer 14 at 80 kHz and −3 dB, with embodiments of three other transducer assemblies 38, 40 and 42 which have the same number (seven) and size of transducer elements 30 as transducer assembly 28, but with different radii of curvature. The transducer assembly 38 can have a radius R=10λ or 7.38 inches, with an arc angle D of about 15°, an angular spacing angle E of about 2.5°, and an acoustic beam 16 with an angle θ of about 17° in the axis B direction. The transducer assembly 40 can have a radius R=2λ, or 1.48 inches, an arc angle D of about 65°, an angular spacing angle E of about 10.8°, and an acoustic beam 16 with an angle θ of about 33° in the axis B direction. The transducer assembly 42 can have a radius R=¾λ of about 0.55 inches, an arc angle D of about 180°, an angular spacing angle E of about 30°, and an acoustic beam 16 that is primarily formed by the five inner transducer elements 30 in view that the two end transducer elements 30 direct initial acoustic beams 15 in opposition to each other inside housing 18. Transducer assembly 28 can have a radius R=1λ of 0.74 inches, an arc angle D of about 130°, an angular spacing angle E of about 21.6°, and an acoustic beam 16 with an angle θ of about 101° in the axis B direction.

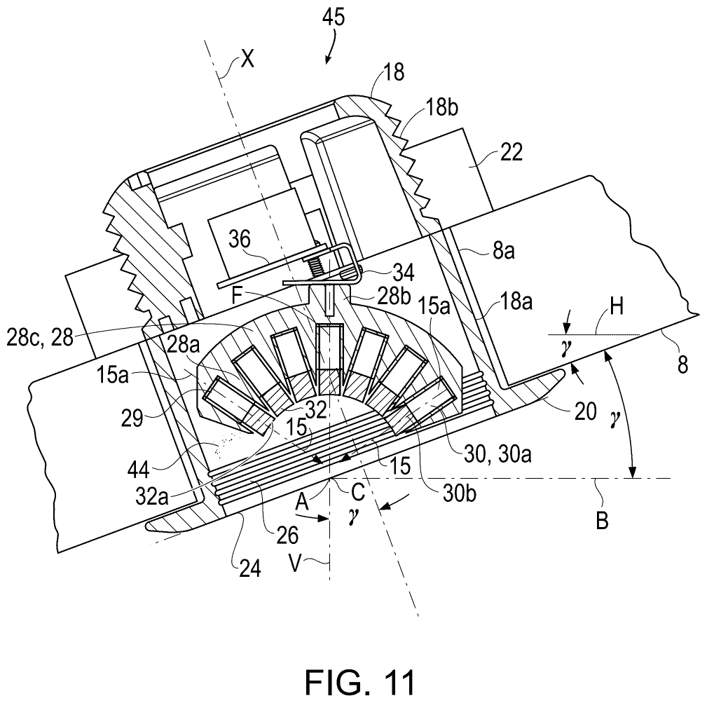

Referring to FIG. 11, acoustic fish finder, marine transducer, or transducer device 45 can be mounted to a portion of the hull 8 that is at an angle γ relative to horizontal H, for example at 20°, and differs from transducer 14 in that the transducer assembly 28 is mounted within the housing 18 in a manner where the center axis F of the transducer assembly 28 is tilted at the same angle γ relative to the longitudinal axis X of the housing 18, so that the center axis F is aligned with vertical axis V for directing the acoustic beam 16 downwardly into the water 12. The port—starboard direction axis B is parallel to horizontal H and at angle γ relative to the hull 8. Although the transducer assembly 28 is positioned at an angle within the interior 26 of housing 18, the concave shape of the acoustic emission portion 32a can still direct the initial acoustic beams 15 out exit window 24 and form a collective acoustic beam 16 that can exit the exit window 24 without shadowing or portions being blocked by the sidewalls 18a of housing 18. In other embodiments, transducer 45 can have other angles γ to accommodate hulls at different angles, for example 12°.

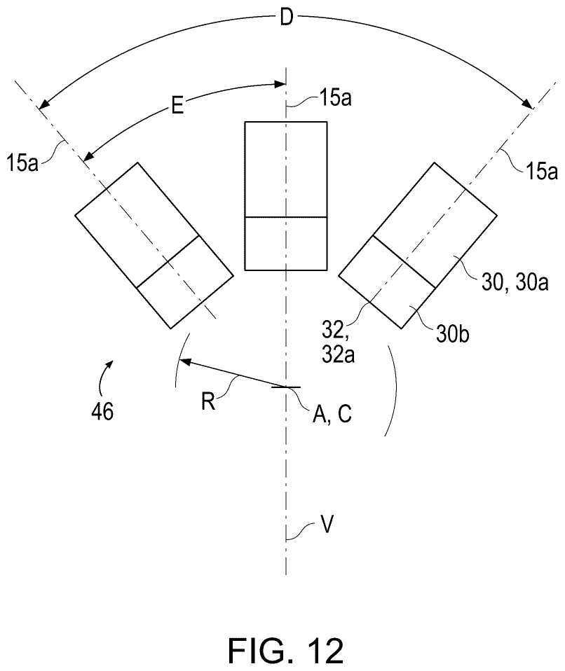

Referring to FIG. 12, transducer assembly 46 differs from transducer assembly 28 in that transducer assembly 46 only includes three transducer elements 30 in which the emission surfaces 32 are positioned on a radius of curvature of R=1λ. The axes 15a of the transducer elements 30 can be separated from each other an angle E of about 40°, and the total arc angle D can be about 80°.

Although 3 to 7 transducer elements 30 have been described above for the transducer assemblies, in some embodiments more than seven transducer elements 30 can be included to form a smoother concave emission portion 32a, and can result in a more even acoustic beam 16. Although embodiments of the present disclosure transducers can have transducer elements 30 that are arranged to form a concave emission portion 32a having a circular arch or arc shape with a constant radius R, other embodiments can have concave emission portions 32a in which the arch shape is not a circular shape, for example a concave shape having a curved surface with varying radii over the surface (curves of different radii connected together), or a combination of curves and straight lines. Also, depending upon the number and size or width of transducer elements 30 used, the shape of the concave emission portion 32a in some embodiments can be considered to have a concave polygonal shape with straight line segments rather than a curved shape. In addition, the length L₁ or L₂ of each transducer element 30 can be formed by assembling multiple shorter pieces of piezoelectric members together. Although the initial acoustic beams 15 can be generated simultaneously by the transducer elements 30, in some embodiments, there can be a time delay between the generation of the initial acoustic beams 15 from the different transducer elements 30. Additionally, in some embodiments, the concave emission portion 32a can be formed from piezoelectric arc segments.

While example embodiments have been particularly shown and described, it will be understood by those skilled in the art that various changes in form and details may be made therein without departing from the scope of the embodiments encompassed by the appended claims. For example, although particular dimensions have been provided, is understood that dimensions can vary depending on the situation at hand, such as the size of the piezoelectric transducer elements 30 and housing 18. In addition, various features of the different embodiments can be combined together or omitted.

What is claimed is:

1. A transducer device comprising:
a transducer element configuration having an acoustic emission portion that has a concave shape for generating a series of acoustic beams that cross each other to collectively form a wide-angle acoustic beam.

2. The device of claim 1 in which the transducer element configuration comprises a series of individual transducer elements each having an acoustic emission surface, that are positioned in a concave arrangement.

3. The device of claim 2 in which the individual transducer elements are arranged around a radius of curvature of ¾λ to 10λ, where λ is the wavelength of water at 80 kHz.

4. The device of claim 3 in which the transducer elements are arranged around a radius of curvature of 1λ.

5. The device of claim 3 in which the transducer element configuration comprises seven individual transducer elements, each having a length and a width that extend along respective longitudinal and lateral directions, the radius of curvature extending around the longitudinal direction.

6. The device of claim 5 in which the wide-angle acoustic beam at −3 dB is about 55° to 206° in the lateral direction and about 13° to 40° in the longitudinal direction.

7. The device of claim 5 in which the wide-angle acoustic beam at −3 dB is about 57° to 73° in the lateral direction and about 16° in the longitudinal direction.

8. The device of claim 2 further comprising a generally circular housing surrounding the transducer element configuration, the housing having a window through which the wide-angle acoustic beam passes.

9. The device of claim 2 in which the individual transducer elements are secured within a mounting fixture that positions the transducer elements in the concave arrangement.

10. The device of claim 2 in which the transducer element configuration includes 3 to 7 transducer elements.

11. The device of claim 8 in which the individual transducer elements are elongate and each have a length, the transducer elements being positioned laterally relative to each other, the lengths of the transducer elements at opposite lateral sides of the transducer element configuration being shorter in length than any transducer elements therebetween in order to fit within the generally circular housing.

12. A transducer device comprising:
a transducer element configuration having an acoustic emission portion that has a concave shape, comprising seven individual transducer elements each having a length and width that extend along respective longitudinal and lateral directions, the transducer elements each having an acoustic emission surface, are positioned in a concave arrangement around a radius of curvature of 1λ, the radius of curvature extending around the longitudinal direction, the acoustic emission portion for generating a series of acoustic beams that cross each other to collectively form a combined wide angle acoustic beam.

13. A method of generating a wide-angle acoustic beam with a transducer device comprising:
generating a series of acoustic beams that cross each other to collectively form the wide-angle acoustic beam with a transducer element configuration having an acoustic emission portion that has a concave shape.

14. The method of claim 13 in which the transducer element configuration comprises a series of individual transducer elements, each having an acoustic emission surface, that are positioned in a concave arrangement.

15. The method of claim 14 in which the individual transducer elements are arranged around a radius of curvature of ¾λ to 10λ, where λ is the wavelength of water at 80 kHz.

16. The method of claim 15 in which the transducer elements are arranged around a radius of curvature of 1λ.

17. The method of claim 15 in which the transducer element configuration comprises seven individual transducer elements, each having a length and width that extend along respective longitudinal and lateral directions, the radius of curvature extending around the longitudinal direction.

18. The method of claim 17 further comprising generating the wide-angle acoustic beam at −3 dB to be about 55° to 106° in the lateral direction and about 13° to 40° in the longitudinal direction.

19. The method of claim 17 further comprising generating the wide-angle acoustic beam at −3 dB to be about 57° to 73° in the lateral direction and about 16° in the longitudinal direction.

20. The method of claim 14 in which the transducer device further comprises a generally circular housing surrounding the transducer element configuration, the housing having a window, the method further comprising emitting the wide-angle acoustic beam through the window of the housing.

21. The method of claim 14 in which the individual transducer elements are secured within a mounting fixture that positions the transducer elements in the concave arrangement.

22. The method of claim 14 in which the transducer element configuration includes 3 to 7 transducer elements.

23. The method of claim 20 in which the individual transducer elements are elongate and each have a length, the transducer elements being positioned laterally relative to each other, the lengths of the transducer elements at opposite lateral sides of the transducer element configuration being shorter in length than any transducer elements therebetween in order to fit within the generally circular housing.
